(19) United States
(12) Patent Application Publication
(10) Pub. No.: US 2010/0028548 A1
(43) Pub. Date: Feb. 4, 2010

(54) EQUIPMENT FOR GLUING THE FINAL TAIL OF ROLLS OR LOGS OF SHEET MATERIAL

(75) Inventors: Mauro Biagioni, Lucca (IT); Sergio Casella, Lucca (IT); Richard J. Vigneau, Green Bay, WI (US)

Correspondence Address: GREER, BURNS & CRAIN, 300 S WACKER DR, 25TH FLOOR, CHICAGO, IL, 60606, US

(73) Assignee: PAPER CONVERTING MACHINE COMPANY, Green Bay, WI (US)

(21) Appl. No.: 12/476,624

(22) Filed: Jun. 2, 2009

(30) Foreign Application Priority Data
Jul. 31, 2008 (IT) MI 2008A 001434

(51) Int. Cl. B05D 1/28; B05C 1/08

(52) U.S. Cl. 427/428.14; 118/262

(57) ABSTRACT

Apparatus for gluing the final tail of rolls or logs of wound sheet material includes a glue distributor device located below an opening in a roll down table. The tail of the roll is separated from the roll by a tail separating unit upstream of the opening. The gluing distributor device includes a tank containing glue, a rotatable pick up roll located inside of the tank and partially immersed in the glue, and a glue distributor roll positioned externally above the tank and provided with at least one paddle. The pick up roll picks up glue as it rotates, and the rotating paddle contacts the pick up roll and picks up glue as the glue distributor roll rotates. The paddle rotates into the opening in the roll down table, and glue is transferred from the paddle to a roll as the roll rolls over the opening. A cull roll can be culled without applying glue to the roll by mounting a cull roll support projection on the glue distributor roll which is not long enough to contact the pick up roll. The cull roll support projection is positioned in the opening in the roll down table when the cull log rolls over the opening.

### RELATED APPLICATION

Applicants claim priority of Italian Patent Application No. MI 2008A 001434, filed Jul. 31, 2008.

### BACKGROUND

The present invention relates to equipment for the gluing of the final tail of rolls or logs of sheet material, particularly paper.

It is known in the paper converting industry, for example, in producing hygienic paper rolls such as bathroom tissue and kitchen towels, to use machines called rewinders which unwind a web or sheet of paper from a large diameter reel or parent roll and rewind the web onto tubular cores, thereby producing rolls or logs with a diameter fit for the intended use. These machines work continuously is and cause the separation of the sheet at the end of the winding of each log, thereby providing a final tail of the finished log and an initial tail of the next log, which need to be glued, respectively, to the formed log and to the tubular core of the new log.

The invention particularly relates to the gluing of the final tail of the formed log.

There are various systems for the gluing of the final tail, which normally consist of unwinding the tail of the formed log, applying glue on the inside, for example through a distributing nozzle, and rewinding the tail onto the log, to which it then remains glued.

Other systems apply a layer of glue along a line of the cylindrical surface of the log, against which the final tail is then applied.

European Patent No. 0 481 929 B1 describes a gluing device of this type, where the glue is distributed by overflowing from an upwardly oriented slit of a glue dispenser located on the rotating trajectory of the log. This overflowing glue dispenser has the disadvantage of distributing the glue continuously, with the consequent contamination of logs that do not need the glue application, for example, because they are defective.

European Patent No. 0 699 168 B2 partly solves this problem, proposing to place at the inside of the glue dispenser a movable device normally immersed in the glue and which is moved towards the upwardly oriented slit of the glue container to apply the glue to the log when it rolls over the slit. This solution does not completely eliminate the problem of the paper contamination, considering that the movable element is completely immersed in the glue in the container and does not allow varying the quantity of glue to be applied to the roll, unless by substituting the movable device.

### SUMMARY OF THE INVENTION

The aim of the invention is to eliminate the above mentioned problems.

In particular, one aim of the invention is to avoid contamination of the log.

Another aim of the invention is to allow handling the glue quantity to be applied in a simple way.

One more aim of the invention is to allow a uniform glue distribution on the whole line of the log or on segments of it.

The device of the invention provides a pick up roll, partially immersed in glue in a tank, which transfers measured quantities of glue to a glue applicator or glue distributor roll. In the preferred embodiment of the invention, the glue applicator roll includes at least one paddle, blade, or projection which extends out more or less radially from its profile. The paddle, blade, or projection picks up a predetermined quantity of glue from the external surface of the pick up roll and transfers the glue to the log surface through a transverse opening in the log roll down table.

By varying the angular speeds and/or the rotation senses of the pick up roll and of the paddle carrying roll, based also on the number of the latter, it is possible to handle with precision the glue quantity which is transferred to the log.

The end of the glue distributing paddle can be shaped to optimize the quantity of glue which is collected and transferred to the log. For example, the end of the paddle can be provided with a groove to contain the glue, and/or the transverse width of the end of the paddle can be varied.

The handling of the collected glue quantity can also be adjusted by using one of several superficial finishes of the pick up roll. For example, a smooth surface will pick up less glue and will therefore transfer less glue to the distribution paddle. A rough surface will pick up more glue and transfer more glue to the paddle.

More characteristics of the invention will become clearer from the detailed description below.

### DESCRIPTION OF THE DRAWING

Further characteristics of the invention will be made clearer by the detailed description that follows, referring to purely exemplary and therefore non-limiting embodiments thereof, illustrated in the appended drawings, in which:

FIG. 1 is side elevational view, partially in section, of an apparatus is formed in accordance with the invention in which a log is located between a pair of tail locating rollers;

FIG. 2 is a view similar to FIG. 1 showing the rotation of the tail locating rollers, the log, the glue pick up roll, and the glue applicator roll;

FIG. 3 is a view similar to FIGS. 1 and 2 showing the log rolling toward the glue applicator roll;

FIG. 4 is a view similar to FIGS. 1-3 showing glue being applied to the log;

FIG. 5 is a view similar to FIG. 4 but in which the glue applicator roll is in a position so that no glue is applied to a log which is to be culled and the cull log is discharged without glue being applied;

FIG. 6 is an enlarged fragmentary view of a paddle for transferring glue to the log which is provided with a groove in its outer end;

FIG. 7 illustrates a modified glue applicator roll which includes a log support blade or projection which supports, but does not apply glue to, a cull log as the cull log rolls over the glue applicator roll; and

FIG. 8 illustrates another modified glue applicator roll which supports, but does not apply glue to, a cull log as the cull log rolls over the glue applicator roll.

### DESCRIPTION OF SPECIFIC EMBODIMENTS

Referring to the drawing, the numeral 1 designates generally a tail sealing apparatus for gluing the final tail of rolls or logs of convolutely wound ribbon-like material, which may be referred to as a web or sheet. The tail sealing apparatus may be included, for example, in a conventional rewinder which is well known in the paper converting art for forming rolls of bathroom tissue and kitchen towels. Accordingly, the details of the rewinder need not be further described.

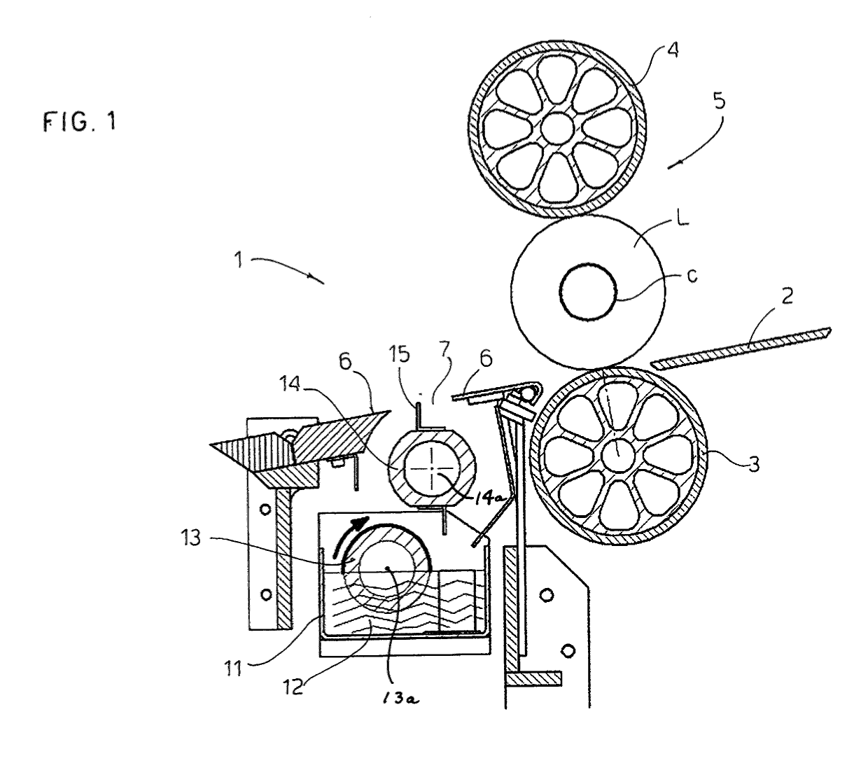

Referring to FIG. 1, wound rolls or logs L are discharged from the rewinding device (not shown but located upstream and to the right in FIG. 1) and roll down an entry table 2. The log L illustrated in the drawing includes an elongated central tubular core C, but it is well known in the art that this core can be omitted, and the sheet material, in particular paper, can be wound centrally on itself.

Downstream of the table 2 is located a tail unwinding or tail separating apparatus 5, which includes a pair of opposed rolls—a lower roll 3, whose profile is very close to or slightly projecting above the extension of the table 2, and an upper roll 4. This unwinding apparatus serves to unwind or separate the final tail from the log L, as will be explained more fully below.

The preferred tail unwinding unit 5 is described in detail in U.S. Pat. No. 5,800,652. However, other units known in the art for unwinding or separating the tail from the log can be used, for example, a unit which uses unwinding belts. Other devices for unwinding or separating a tail from a log are described, for example, in European Patent Nos. 0 481 929 B1 and 0 699 168 B2, British Patent No. 1 495 445, and U.S. Pat. Nos. 4,475,974, 4,963,223, and 5,242,525.

Downstream of the unwinding unit 5, a roll down table 6 is provided, which is substantially in alignment with the table 2 and which is provided with a transverse opening 7. The transverse dimension of the opening 7 extends transversely to the longitudinal axis of the log. The length or longitudinal dimension of the transverse opening 7 extends parallel to the longitudinal axis of the log, i.e., across the width of the roll down table, and may be continuous or discontinuous along the length of the log.

The gluing device of the invention, generally designated by the reference numeral 10, is located below the roll down table 6 in alignment with the transverse opening 7. The gluing device 10 includes a tank 11 which extends parallel to the axis of the log, below the opening 7, and which is partially filled with liquid glue or adhesive 12.

An elongated pick up roll 13 is located in the glue tank 11 and is partially immersed in the glue 12. The pick up roll is kept in rotation about its axis 13a, for is example, in a clockwise direction as indicated by the arrows in the enclosed figures. Any suitable drive mechanism for rotating the pick up roll can be used.

Above and outside the tank 11 a second elongated rotatable roll 14 is provided, on which one or more (in the example two) glue distribution paddles, blades, or projections 15 are fixed. The axis 14a of the roll 14 is parallel to the axis 13a of the roll 13 and is preferably located in a vertical plane which is spaced from the vertical plane containing the axis of the roll 13. The distribution paddles 15 project substantially radially from the surface of the roll 14. Preferably, in the case of the two paddles 15 shown in the figures, the paddles are located in parallel planes which are parallel to, and spaced from, a plane passing through the axis of the roll 14.

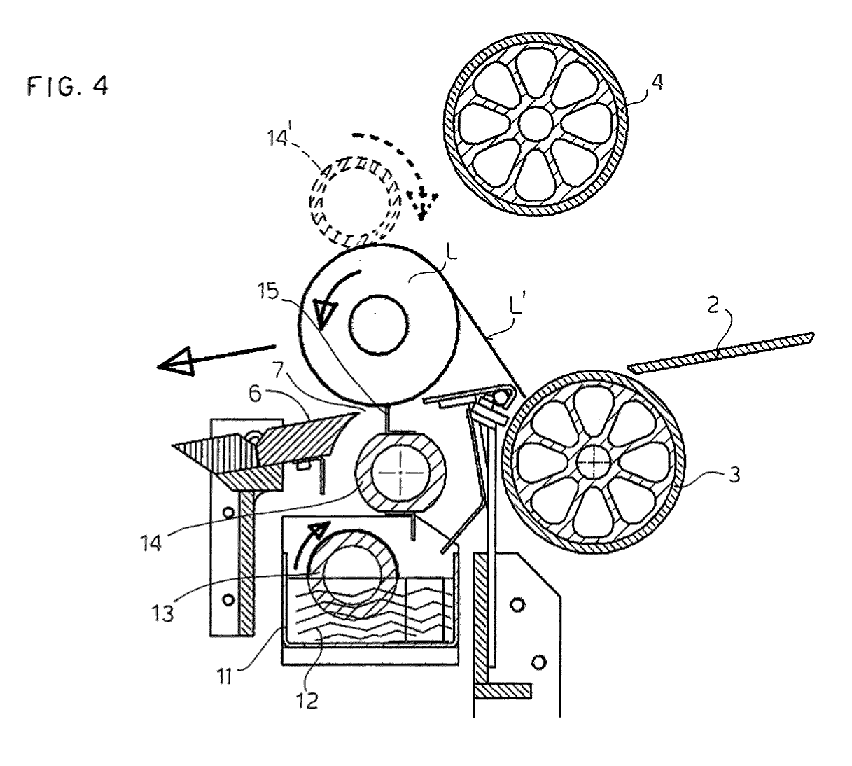

The staggering or spacing of the two axes of the rolls 13, 14 and the staggering or spacing between the planes of the paddles 15 allows an optimal transfer of the glue and guarantees the detachment of one of the paddles 15 from the surface of the pick up roll 13 while the other paddle is in position of glue distribution on the log L (see FIG. 4 in particular).

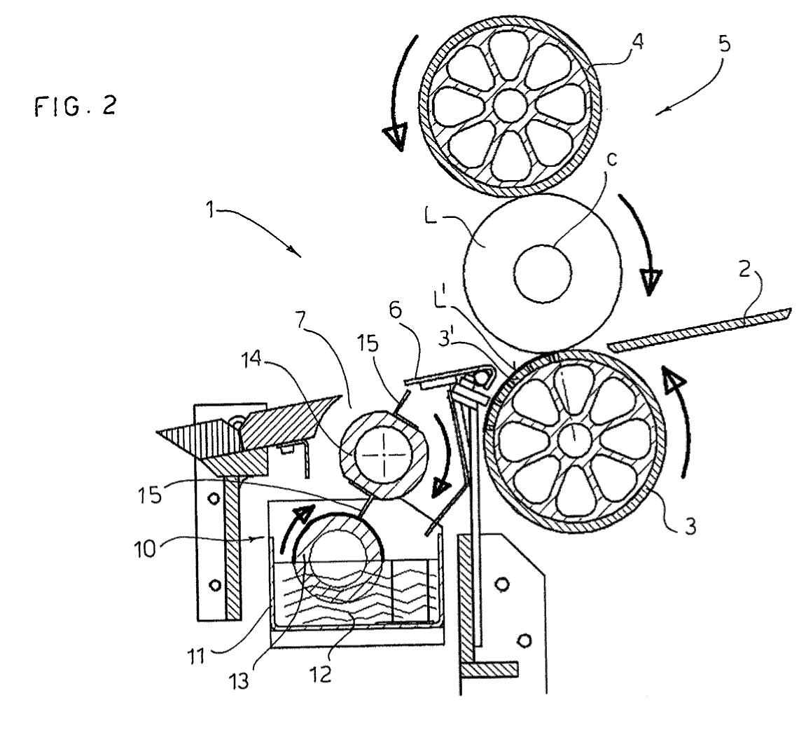

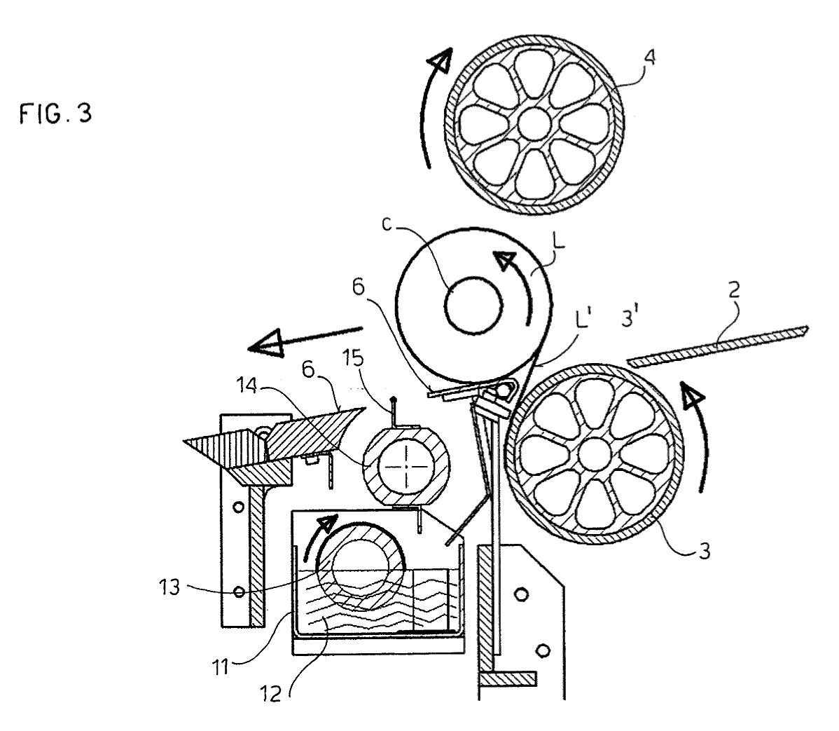

The glue distributor roll 14 is rotated at a speed that depends on the number of cycles (logs per minute to be glued) and on the number of paddles 15 fixed on its surface. Each paddle 15 picks up a suitable quantity of glue which is deposited on or adheres to the external surface of the pick up roll 13 (FIG. 2) and rotates into the opening 7 of the discharge table 6 before a log L reaches the opening (FIG. 3).

Another advantage of the invention is that, considering that the paddle 15 is a rigid support for the log in transit over the opening 7, the opening can be wider, thereby resulting in less glue dirt or contamination on the roll down table 6.

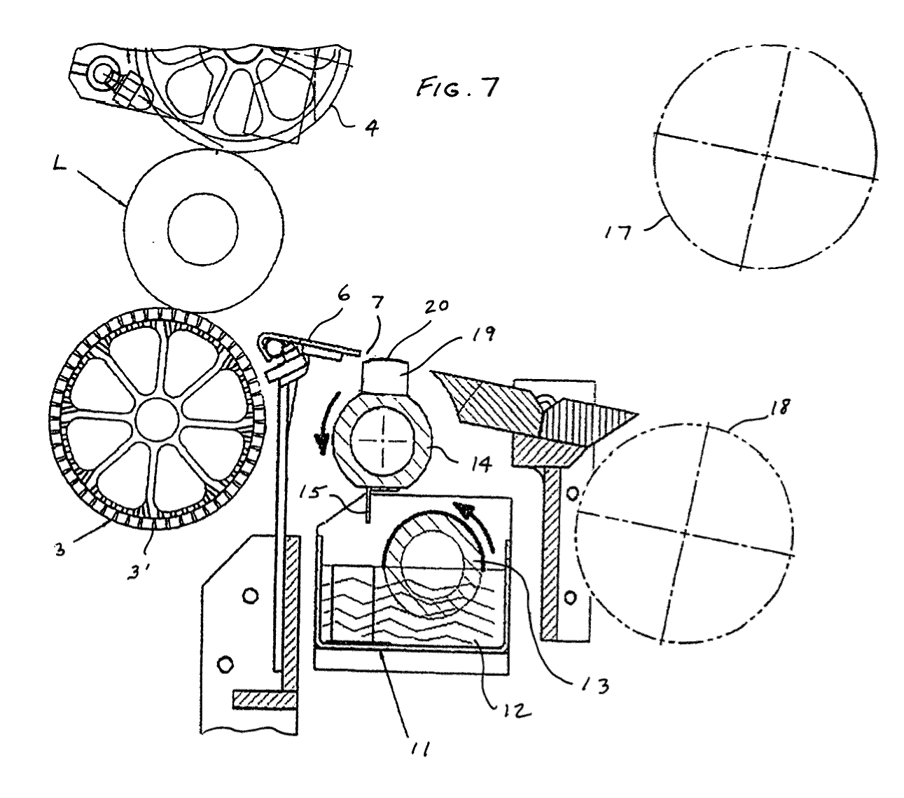

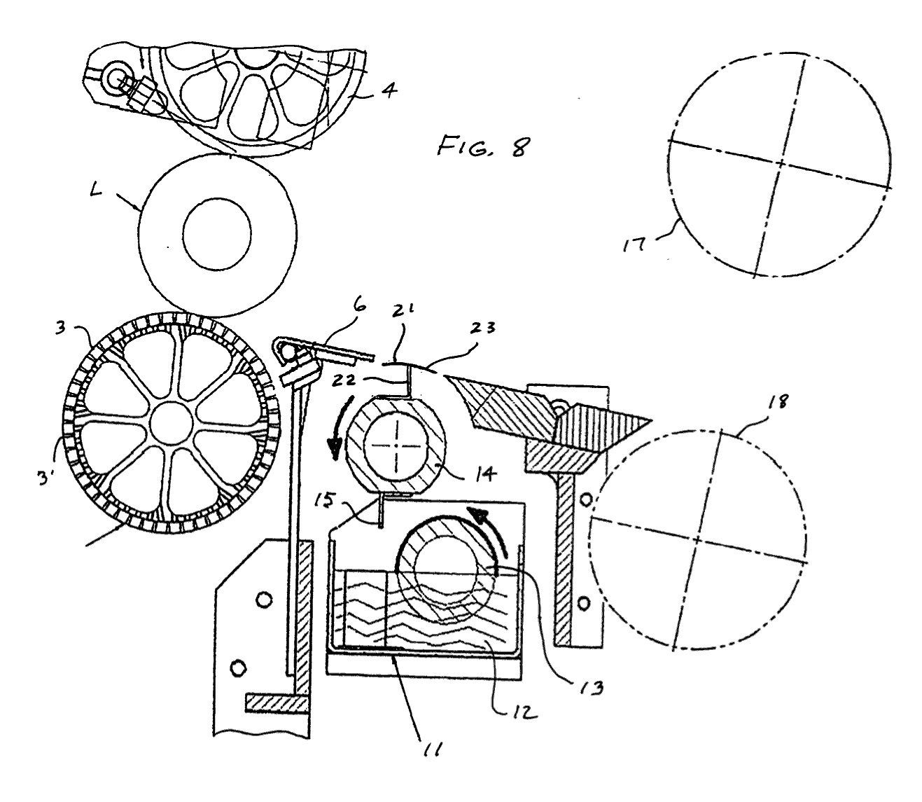

Referring to the sequence shown in the drawing, the succession of the phases which accomplish the gluing of the final log tail is now described. In FIG. 1, the log L coming from the entry table 2 reaches the unwinding unit 5, between the two opposed rolls 3, 4. As described in U.S. Pat. No. 5,800,652, the lower roll 3 is a suction or vacuum roll and is provided with at least one perforated baffle 3′ (FIGS. 2 and 7). In FIG. 2 the rolls 3 and 4 are rotating counterclockwise at the same speed as indicated by the arrows, to rotate the log L clockwise to separate the tail L′ from the log and to unwind the tail L′ onto the lower roll 3. The tail L′ is held on the lower roll 3 by the suction which is exerted on the tail through the perforations in the lower roll.

In FIG. 2, the glue distributor roll 14 is in rotation, and a paddle 15 enters into contact with the pick up roll 13, collecting a sufficient quantity of glue on its end.

In FIG. 3, the rotation of the upper and lower rolls is reversed to clockwise rotation and the rotation of the upper roll 4 is accelerated with respect to the rotation of the lower roll 3. The log L is thereby expelled from the unwinding unit and begins to roll counterclockwise on the roll down table 6. In the meantime, the glue distribution paddle 15 continues to rotate until it is in the gluing position, in the opening 7 of the discharge table 6, before the passage of the log L, as illustrated in FIG. 3.

However, it is obvious that the paddle 15 can also be moved in synchronism with the log L, detecting with sensors the position of the log on the discharge table 6, in a way to come in contact with the surface of the log L when the paddle transits the opening 7, without stopping, in order to optimize the gluing times.

To optimize the gluing and the managing of the movement in synchronism between the movement of the paddle 15 and the transit of the log on the opening 7, a roll 14′ (shown with a broken line in FIG. 4) can be installed in position above the distribution unit. The roll 14′ permits:

better managing the traversing speed of the log on the glue distributing element, considering also the discordant movement of the paddle if it is moved in synchronism with the log instead of being in stationary position;

improving the contact between the glue distributing element and the log.

Alternatively, if desired, the log can be stopped over the opening in the roll down table and the paddle 15 can be rotated into contact with the stopped log.

In FIG. 4 the log L is shown in the rolling phase over the opening 7 in the discharge table 6, entering into contact with the paddle 15, from which it receives a layer or line of glue along its generatrix. The vacuum in the lower roll 3 has been shut off, and the tail L′ is released from the roll 3 as the log rolls to the left. As the log continues to roll, the tail L′ is rewound onto the log and is secured by the glue.

After the phase illustrated in FIG. 4, the log L is discharged from table 6, and the tail L′ may be further secured in a known way, for example, by making the log transit between a pair of opposed rolls 17 and 18 (FIGS. 7 and 8) rotating at different speeds.

The pick up roll 13 and/or the distributing paddles 15 and/or the glue containing tank 11 and/or the opening 7 can be continuous in the longitudinal direction for the whole length of the log generatrix (i.e., parallel to the axis of the log), or they can be discontinuous or interrupted. The second case optimizes glue consumption and/or avoids glue contaminaton of the cutting elements of the log saws which cut the log transversely into shorter rolls. If the rolls 3 and 4 are not continuous in the direction of the log length, it is possible to install intermediate supports for the rolls and reduce the diameter of the rolls for long log lengths.

The management of the quantity of glue collected by the paddles 15 may be controlled by controlling the differential speed between the pick up roll 13 and the distributor roll 14, increasing or decreasing the contact time and therefore the transferred glue quantity. The extremity of the paddle 15 can also be shaped in a way to optimize and control the amount of the collected glue. For example, the end of the paddle can be provided with a groove 15a (FIG. 6) to contain the glue, and/or the transverse width of the paddle can be increased or decreased.

The management of the collected glue quantity can also be accomplished by using different superficial finishes of the pick up roll 13. A smooth surface will mean less glue will adhere to or be deposited on the pick up roll, and less glue will therefore be transferred to the distributing paddle 15. Conversely, a rougher surface on the pick up roll 13 will pick up more glue, and more glue will be transferred to the paddle 15.

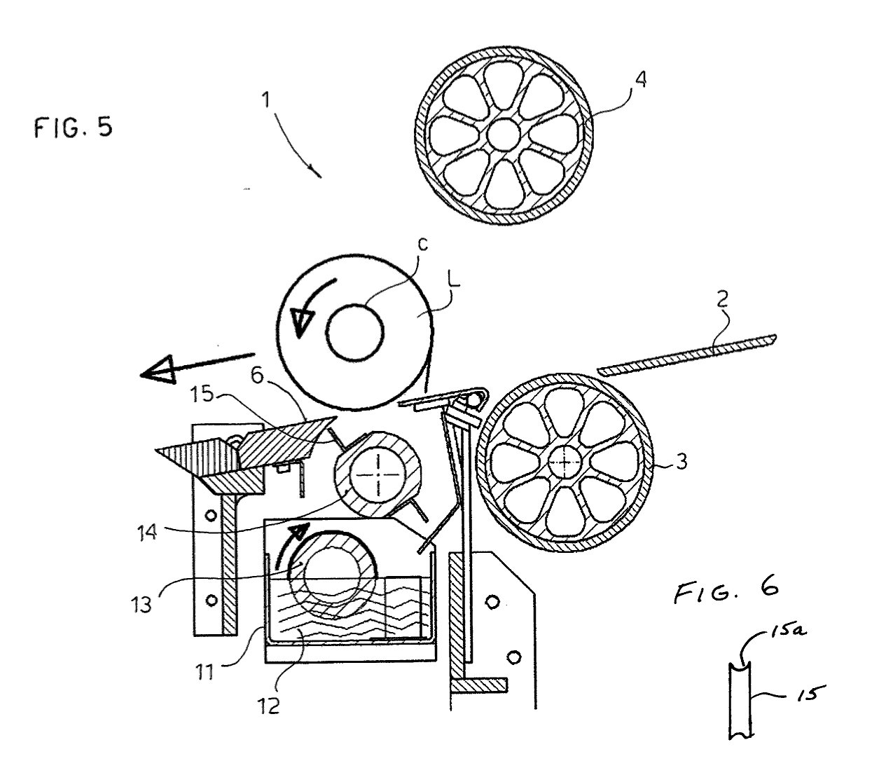

FIG. 5 represents a situation where it is necessary to cull the log L, for example, if the log is imperfectly formed and should be discarded. The distributor roll 14 is rotated to a position so that the paddle 15 is in a position of non-interference with the log, i.e., the log will not contact the paddle as the log rolls over the opening 7. This can be accomplished, if the paddle 15 is already in position in the opening 7, by rotating the roll 14 rotate slightly counterclockwise. Alternatively, with a different management of the movement of the distributor roll 14, the rotation of the roll 14 can be stopped before the paddle 15 arrives in the opening 7 of the discharge table 6.

In FIG. 5 the log rolls over a relatively wide opening 7 and is not supported by the paddle 15. An alternative approach to culling a log without applying glue allows the log to be supported as it rolls over the opening. When the control system of the machine issues a cull signal for a log, the distributor roll 14 will not rotate from the position in which the previous log rolled over the paddle 15 in the opening 7 and picked up most or all of the glue from the paddle. The cull log will then roll over a spent paddle, i.e., a paddle with little or no or substantially no glue on it.

FIGS. 7 and 8 illustrate other alternatives for culling a log without applying glue to it. FIGS. 6 and 7 illustrate a tail sealing apparatus which is similar to the apparatus of FIGS. 1-5, but the direction in which the log L rolls down the roll down table 6 is from left to right.

In FIG. 7 the distributor roll 14 includes one or more paddles 15 as previously described but also includes a roll support projection 19 which extends generally radially from the roll 14. The projection 19 is shorter than the paddle 15, and the end of the projection does not contact the glue 12 in the glue tank 11 as the distributor roll 14 rotates. The projection 19 therefore does not pick up glue from the glue tank. However, the projection is long enough to support a cull log when the cull log rolls over the opening 7 in the roll down table 6.

When the control system of the machine issues a cull signal, the control system will rotate the distributor roll 14 so that the roll support projection 19 is positioned in the opening 7 in the roll down table 6. The roll support projection 19 supports the cull log as the cull log rolls over the opening 7, and glue is not applied to the cull log. The outer end of the cull support 19 advantageously includes a rounded or radiused surface 20 to facilitate rolling of the cull log over the support.

In FIG. 7 a single cull support 19 is opposite a single paddle 15. However, additional cull supports and/or paddles can be added to the distributor roll 14. For example, two diametrically opposed paddles and two diametrically opposed cull supports could be spaced 90 degrees apart around the distributor roll. Alternatively, two paddles and one cull support could be spaced 120 degrees apart.

In FIG. 8 the distributor roll 14 includes a paddle 15 and a roll support projection 21. The roll support projection 21 includes a generally radially extending rib 22 and a curved end plate 23 for supporting a cull log as the cull log rolls over the opening 7. The radial dimension of the rib 22 is such that the end plate 23 does not contact the glue 12 as the distributor roll 14 rotates.

The distributor roll 14 of FIG. 8 can also be provided with more paddles 15 and/or roll support projection 21 as described with respect to FIG. 7.

Considering the above, the advantages of the invention—as explained previously—appear to be evident. Obviously the invention is not limited to the particular embodiments described previously and illustrated in the enclosed drawings, but numerous detail modifications can be made to it, within the reach of a technician's skill, remaining within the field of the invention defined by the following claims.

We claim:

1. Apparatus for gluing the final tail of a roll of wound sheet material having a final tail comprising:
a tail separating unit for separating the final tail from the roll,
a roll down table located downstream from the tail separating unit and having an opening therein,
a glue distributing device located under said opening in the roll down table, said glue distributing device including:
a tank containing glue,
a rotatable pick up roll located inside the tank and partly immersed in the glue, and
a rotatable glue distributor roll positioned externally above the tank and provided with at least one paddle able to collect a quantity of glue from the external surface of the pick up roll and to transfer the glue to a roll when the roll is over said opening in the roll down table.

2. The apparatus of claim 1 in which said pick up roll and said distributor roll are rotatable at a controlled differential speed, based on the quantity of glue to be transferred to said paddle.

3. The apparatus of claim 1 in which each of the pick up roll and the glue distributor roll have axes of rotation which are located in vertical planes which are parallel and spaced apart from each other.

4. The apparatus of claim 1 in which the glue distributor roll is provided with two paddles which are located in parallel planes, the glue distributor roll having an axis of rotation which is parallel to and substantially equidistant from said parallel planes.

5. The apparatus of claim 1 in which said paddle includes an end which is provided with a groove.

6. The apparatus of claim 1 in which said pick up roll and said glue distributor roll extend continuously for the entire length of the roll.

7. The apparatus of claim 1 in which said paddle is moved into said opening in the roll down table before the roll moves over the opening.

8. The apparatus of claim 1 including a synchronism roll above said opening in the roll down table and above the distributor roll.

9. The apparatus of claim 1 in which the glue distributor roll includes a cull roll support projection having a length such that the cull roll support projection does not contact the pick up roll as the glue distributor roll rotates whereby the cull roll support projection does not pick up glue from the pick up roll and can be positioned in the opening in the roll down table when a cull roll rolls over the opening.

10. The apparatus of claim 9 in which the cull roll support projection includes a curved surface for contacting and supporting the cull roll.

11. A method of gluing the final tail of a roll of sheet material comprising the steps of:
separating the final tail from the roll,
rolling the roll down a roll down table having an opening therein,
positioning a glue tank containing glue below the opening in the roll down table,
rotating a pick up roll in the glue so that the surface of the pick up roll picks up glue,
rotating a glue distributor roll above the pick up roll, the glue distributor roll being provided with at least one paddle, so that the paddle contacts the glue distributor roll and picks up glue therefrom,
rotating the glue distributor roll so that the paddle moves into the opening in the roll down table and glue is transferred from the paddle to a roll as the roll rolls over the opening in the roll down table.

12. The method of claim 11 in which the paddle is rotated into the opening in the roll down table before the roll rolls over the opening.

13. The method of claim 11 in which the paddle is rotated into the opening in the roll down table in synchronism with the roll rolling over the opening.

14. The method of claim 11 in which the pick up roll and the glue distributor roll are rotated at different speeds.

15. The method of claim 11 in which the quantity of glue which is transferred from the paddle to the roll is varied by varying the differential speed of rotation between the pick up roll and the glue distributor roll.

16. The method of claim 11 in which after glue is transferred from said paddle to a roll said paddle is positioned in said opening without picking up additional glue, and rolling a cull log over the opening so that the cull log is supported by the paddle and substantially no glue is applied to the cull log.

17. The method of claim 11 in which the glue distributor roll includes a cull roll support projection which does not contact the pick up roll as the glue distributor roll rotates, positioning said cull roll support projection in said opening in the roll down table when a cull roll rolls over the opening so that the cull roll support projection supports the cull roll without applying glue to the cull roll.
